(19) United States
(12) Patent Application Publication
(10) Pub. No.: US 2026/0149557 A1
(43) Pub. Date: May 28, 2026

(54) CLOCK AND DATA RECOVERY (CDR) CIRCUITRY UTILIZING BLIND SAMPLING

(71) Applicant: Protocol Insight, Inc., Colorado Springs, CO (US)

(72) Inventors: Anthony Carosa, Colorado Springs, CO (US); Aleksey Tyshchenko, Colorado Springs, CO (US); Edward Brush, Colorado Springs, CO (US); Scott Masepohl, Colorado Springs, CO (US); David Halupka, Colorado Springs, CO (US)

(21) Appl. No.: 19/177,734

(22) Filed: Apr. 14, 2025

Related U.S. Application Data
(60) Provisional application No. 63/634,616, filed on Apr. 16, 2024.

(51) Int. Cl. H04L 7/033; H04L 7/00; H04L 25/03

(52) U.S. Cl. CPC H04L 7/0331; H04L 7/0029; H04L 25/0305

(57) ABSTRACT

A method, system, and apparatus for digital clock and data recovery (CDR) with analog signal that samples blindly (i.e., independent of the baud rate). The CDR further has a digital monolithic circuit that includes an interpolator circuit, and a fully digital clock (FDC) that recovers the digital data from the analog signal.

### CROSS-REFERENCE TO RELATED APPLICATION

This application claims priority to U.S. Provisional Patent Application No. 63/634,616, filed Apr. 16, 2024, entitled “Clock and Data Recovery (CDR) Circuitry Utilizing Blind Sampling,” which is expressly incorporated herein by reference in its entirety.

### BACKGROUND

Test and measurement equipment, including oscilloscopes and protocol analyzers and exercisers are used to debug and test the functionality of various communication channels (e.g., PCI Express, MIPI M-PHY/UniPro, JEDEC UFS, USB, or wireless networks) that allow components and sub-systems to exchange commands and data. The protocol analyzer observes data traffic on communication channels and provides insights into the behavior of devices communicating over these channels. Over the years, both the underlying PHY-layers and the protocols have evolved, but the use of protocol analyzers, however, has remained substantially the same. For protocol analyzers, which capture data being communicated along a communication channel, the “capture session” may be initiated by a user, by identifying an occurrence in the transmitted information (a “trigger event”) that triggers the device to start capture, or by external devices through pre-defined application programming interfaces (APIs).

FIG. 1 illustrates a conventional clock and data recovery (CDR) recovery circuitry 100 for serial protocols. A CDR is used in conjunction with a SERDES, serializer/deserializer, which is an integrated circuit that converts serial data to parallel data, and vice versa. A CDR and SERDES are used for many serial protocols, such as PCI Express, MIPI M-PHY, IEEE 802.3, OIF CEI and may be used in conjunction with a protocol analyzer. The protocol analyzer captures an analog signal (e.g., a data stream) from the communication channel of interest that is input to the CDR recovery circuitry. This analog signal may contain information-bearing transitions (e.g., data bits, clock edges). A continuous time linear equalizer (CTLE) and a variable gain amplifier (VGA) 102 partially equalize the captured signal to condition it for limited analog-to-digital converter (ADC) dynamic range and resolution. The ADC 104 samples and quantizes the partially-equalized signal at 1× the symbol rate for further equalization in a digital signal processor (DSP) 110. A controlled clock source (VCO) 106 or phase interpolator (PI) triggers the ADC 104 to align samples with centers of received data symbols. The VCO 106 generates an oscillating signal (usually a sinusoidal waveform) whose frequency is controlled by an external voltage.

The ADC 104 converts analog signals (such as voltage or current) into digital representations. The ADC 104 samples the analog signal, using a clock generated by the VCO 106 and converts it into a digital format for further analysis. A digital feed-forward equalizer (FFE) 112 and decision-feedback equalizer (DFE) 114 further equalize quantized samples to prepare samples for error-free data recovery. A phase detector (PD) 116 and loop filter (LF) 118 control a clock source to track phase of a received signal. Using the synchronized samples, the protocol analyzer reconstructs the original data, which is then analyzed for errors, timing violations, or protocol compliance. The conventional CDR 100 of FIG. 1 uses phase tracking to maintain synchronization with the transmitted signal's phase. In communication systems, maintaining phase alignment is crucial for accurate data recovery and error detection. When analyzing digital signals, the protocol analyzer tracks the phase of the clock signal or data transitions. It ensures that the sampling points align correctly with the signal transitions.

A disadvantage of the monolithic implementation of FIG. 1 is the complexity of the phase-tracking loop that spans both analog and digital domains, leading to high loop latency and higher costs.

Further, there has long been a desire to combine a real-time protocol analyzer and a real-time oscilloscope in the same instrument. Existing oscilloscopes are not protocol aware; in the sense they cannot decode protocols in real-time. Most oscilloscopes can process saved data and decode protocols. Typically, this is done in software. Some protocol analyzers include an eye viewer function. The eye viewer constructs a view of the “eye”, much like a sampling oscilloscope would, meaning they are not real-time. Often a user is debugging a protocol issue with a protocol analyzer, and they must also use a real-time oscilloscope to aid in understanding the issue. This is problematic for several reasons: the oscilloscope adds cost, time correlating the oscilloscope with the protocol issue can be difficult, and it often requires a separate physical connection, such as an oscilloscope probe and a protocol analyzer probe. This is commonly referred to as “double probing”. Since each probe adds some load, in the form of capacitance, resistance and inductance, having to “double probe” increases the load placed on the system. The present disclosure is the first to offer the capability of a real-time oscilloscope and a protocol analyzer in the same instrument. Both functions are internally time-correlated and use the same single physical connection.

Oscilloscopes incorporate finite impulse response filters that apply equalization in real-time, but without knowledge of the protocol, they are unable to use DFE. Additionally, they do not have the ability to train an equalization algorithm based on an analog input and a protocol decode. Rather, oscilloscopes perform equalization as a post-processing software step. With the digital CDR technology, described in detail below, an oscilloscope would have real-time feedback of the protocol. This would enable real-time DFE and training algorithms to be utilized on oscilloscopes.

A further disadvantage of conventional protocol analyzers, is that they require a dedicated application specific integrated circuit (ASIC), called a “PHY” to recover the serial protocol stream. The PHY converts an analog input to a digital output, and it also tracks the current state of the protocol and changes its operation accordingly. Traditionally, PHYs are monolithic and fully integrated in either an ASIC or field programmable gate array (FPGA).

In addition, protocol-specific PHYs are expensive, requiring massive non-recurring engineering cost to implement. Protocol-specific PHYs are only good for one generation of one protocol. They must be redesigned for different protocols and new generations of protocols. Once the PHYs are designed, they offer little-to-no ability for future modifications. The digital logic cannot be refactored like it can be in an FPGA. This can prove challenging for companies designing PHYs, especially during the prototyping phases of development. Additionally, the PHYs cannot be modified to meet ever-changing specifications and user requirements. It should be noted that these limitations apply to all PHYs, not just PHYs within protocol analyzers.

### SUMMARY

Systems and methods are disclosed herein that provide improved techniques for a digital clock and data recovery (CDR) system. In an aspect, the system may include a blind sampling circuit that includes an analog-to-digital converter (ADC) and a clock that drives the ADC to sample an incoming analog signal to create a sampled signal; and a digital circuit that optionally includes an interpolator circuit, a phase detector (PD), a loop filter (LF) and a digital clock (DC), that recovers the protocol data from the analog signal. A related method of operating the CDR system is also disclosed.

In accordance with an aspect of the present disclosure, there is disclosed a digital clock and data recovery (CDR) system that includes a blind sampling circuit that receives an input sampled signal; and a digital monolithic circuit. The digital monolithic circuit includes a phase detector (PD) that determines a phase error which is used to determine a unit interval (UI) center; and a fully digital clock (FDC) that creates a digital clock used to recover digital data from the input sampled signal.

In accordance with another aspect of the disclosure, there is described a method for sampling an analog input signal. The method may include receiving an input sampled signal at a blind sampling circuit; and recovering digital data from the input sampled signal using a phase detector (PD) that determines a phase error which is used to determine a unit interval (UI) center and a fully digital clock (FDC) that creates a digital clock used to recover digital data from the input sampled signal

Additional aspects of the present disclosure will become apparent in the following discussion, beginning with reference to the accompanying drawings.

### BRIEF DESCRIPTION OF DRAWINGS

The subject matter of the present disclosure will be described in even greater detail below with reference to the figures. All features described and/or illustrated herein can be used alone or combined in different combinations. The features and advantages of various implementations will become apparent by reading the following detailed description with reference to the attached drawings, which illustrate the following:

FIG. 1 illustrates example conventional clock and data recovery (CDR) circuitry that may be used in e.g., PCI Express, MIPI M-PHY, a protocol analyzer;

FIG. 2 an example of a CDR in accordance with the present disclosure;

FIG. 3 is an example of a fully digital clock (FDC) circuit, implemented with a digital algorithm, in accordance with the present disclosure; and

FIG. 4 is an example plot showing a waveform with both blind ADC samples and interpolated edges and centers.

### DETAILED DESCRIPTION

### Introduction

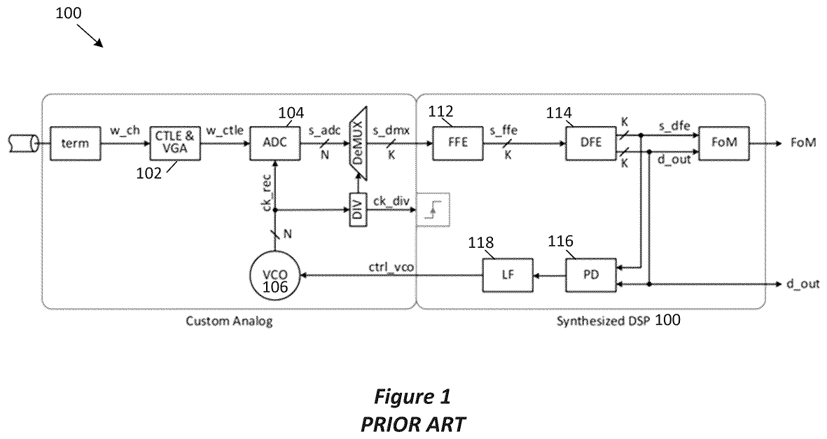

The role of a clock and data recovery (CDR) system is to extract the clock signal embedded in the received data stream and use this timing to recover the data. As described with regard to FIG. 1, traditional CDR architectures use a feedback path with four primary components: a sampler (ADC or other), a phase detector, a loop filter and a voltage-controller oscillator. In these architectures, the sample clock is frequency and/or phase synchronized with the received data.

Implementations of the present disclosure advantageously remove the sample clock from the loop, which removes the high latency that is typical in a clock recovery loop. In accordance with the present disclosure, the ADC sampling clock is free running, with no phase relationship between the samples or symbol boundaries of the received data. The data is sampled by the ADC at a pre-defined clock frequency (sample rate) that is greater than or equal to the received data baud rate, thus the term “blind sampling.” This allows for coupling of a high-performance, low jitter clock source and an ADC with a much higher resolution and dynamic range, when compared to conventional monolithic implementations.

In an aspect, processing by the CDR system of the present disclosure is performed in the digital domain using the digitized samples. The CDR feedback loop is implemented entirely in the digital domain, thus allowing digital logic to act on the ADC samples. FFE, DFE, and phase detection are completely contained in a digital circuit. The digital logic can be implemented in an ASIC, an FPGA or in software. This enables substantial freedom between the input signal, clock source and digital logic. Further advantages include, but are not limited to, separation of development and purchasing of the ADC and ASIC or FGPA. This aspect of the blind-sampling ADC-based receivers makes them highly scalable with the technology nodes, robust to process, voltage and temperature variations, and allows for a short design time due to the automation of the digital design flow.

### Fully Digital Clock (FDC)

As discussed above, in conventional systems such as that of FIG. 1, the phase detector's control signal drives a phase interpolator (PI) or voltage-controlled oscillator (VCO). The purpose of the PI or VCO block is to provide a sample clock source that has fine control of either its frequency and/or phase. This allows the control loop (phase detector (PD) and loop filter (LF)) to adjust the phase of the sample clock (PI or VCO) which tracks the phase of the data being recovered. However, implementations of the present disclosure move the sample recovery loop into the digital domain.

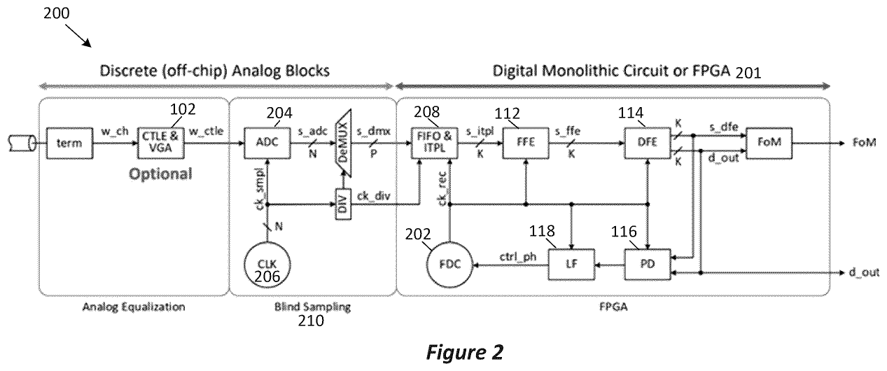

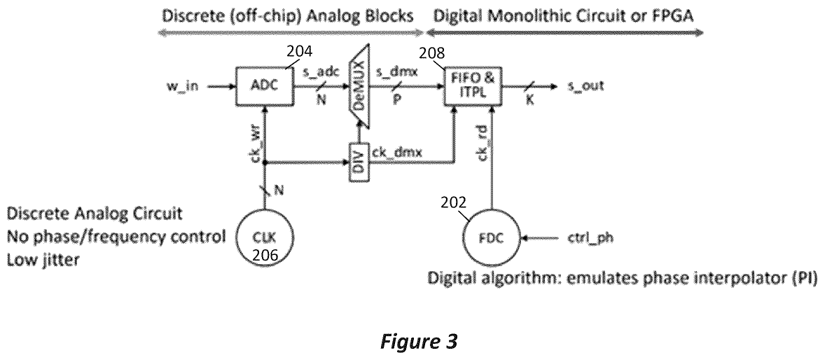

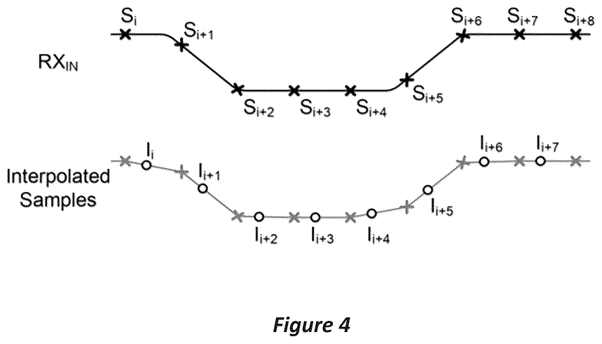

The term “fully digital clock” (FDC) is used herein to replace the traditional terms VCO and/or PI. In particular, the “fully digital clock” (FDC 202) replaces the VCO or PI and creates a clock that can be used in the digital domain. For example, as shown in FIGS. 2 and 3 (described in further detail below), the edge position output of the FDC 202 is used by the interpolator as the sample position for each data symbol. Both the frequency and phase of the digital clock can be adjusted with theoretical infinite resolution (based on the number of bits of resolution one chooses). The control loop will control the phase of digital clock. A separate loop (not shown) can control the frequency of the digital clock. The phase and/or frequency can be changed every clock cycle. This output clock can be any arbitrary frequency and phase and is not related to the clock that is used to control the block, the system clock. The output of the digital clock is the edge position of the sample clock relative to the ADC samples. This edge position output is the ideal sample position. The edge position output is used by the interpolator as the interpolation point, for example, as shown in FIG. 4.

In FIG. 4, RXin is the analog input signal into the ADC 204. The ADC 204 blindly samples the signal, indicated by the Si samples, without knowledge of the baud rate or phase. To recover the clock and data, the FDC 202 interpolates between the blind samples, creating a new set of samples, li. Every UI has two interpolated samples such that one sample is close to the UI center while the other sample is close to the UI edge. The PD 116 utilizes the interpolated UI-edge samples to determine the phase error, fERR, which represents the deviation of these samples from the symbol boundaries in RXin. A digital loop filter then derives the average zero-crossing phase, fAVG, from fERR. An interpolation index updater translates the recovered fAVG into an interpolation index, m, which adjusts the position of the interpolated samples relative to the blind samples, ensuring that li aligns with the UI boundaries and effectively closing the digital feedback loop. The data decision block leverages the interpolated UI-center samples to produce the recovered data. The interpolator within the feedback loop allows this CDR architecture to perform phase tracking entirely in the digital domain.

A novel part of the FDC 202 is the fully digital clock is independent of the input signal or ADC sample clock (e.g., CLK 206). For example, at a given system clock, N samples are received from the ADC. The digital clock will generate M+1 edges based on the frequency of the digital clock, which is the same frequency of the recovered data. Note the +1 is used to account for non-ideal clocks. Thus, N/M is the ADC sample-to-baud rate ratio, where N>M. Below is example that shows how the ADC samples are sampled by the digital clock when the digital clock is in two separate phases relative to the ADC samples. For this example, assume N=10 and M=5, so the ADC sample clock is 2 times the baud rate. In other words, the digital clock frequency is one-half of the ADC sample clock. For the purposes of this example, the ADC samples and numbered from 0 to 11; 0 is the first sample in time. The input phase adjustments and output digital clock are stated relative to the ADC sample clock.

State 1—FDC aligned with ADC: The output of the digital clock is 0,2,4,6,8,10, this indicates that the ideal edge position is at exactly at sample 0, 2, 4, 6, 8 and no interpolation is needed.

State 2—FDC halfway between ADC samples: Starting at state 1, if the phase adjusted by one half of a period, 0.5, of the ADC sample clock, the output of the digital clock would be 0.5, 2.5, 4.5, 6.5, 8.5, 10.5. This indicates that the ideal edge position is halfway between ADC sample 0 and sample 1, halfway between ADC sample 2 and sample 3, etc. In this case, interpolation is required to determine the value of the sample at the point halfway between the samples.

It is important to note that the digital CDR operates on any sampled data, not just that provided by an ADC. In other words, an ADC is not a requirement. Rather, the digital CDR can operate fully in software on any sampled data, such as a simulated waveform or an oscilloscope capture. Additionally, the digital CDR can be applied in an oscilloscope, adding protocol analysis to real-time oscilloscope captures. Lastly, an FPGA is not a requirement. Rather, it's possible to integrate the digital CDR circuitry into a custom ASIC.

### Details of the Digital CDR System and Method

With reference to FIG. 2, there is illustrated an example digital CDR 200 in accordance with the present disclosure. Compared to the conventional CDR 100 of FIG. 1, there are differences as to how baud rate sampling is achieved. For example, in conventional implementations, the VCO 106 output is the ideal sample location which the ADC uses to recover the “baud” rate sample. However, in the implementation of FIG. 2, the ADC 206 is blind sampling and the FDC 202 with interpolation is used to recover the “baud” rate sample. Once the baud rate samples are recovered the remainder of the blocks (e.g., FFE, DFE, PD, LF) may be used conventionally. Yet a further difference from the conventional CDR 100 of FIG. 1 is that the signal pre-conditioning blocks, CTLE and VGA 102, are optional due to a high resolution and dynamic range provided by the ADC 204, and a high precision sampling clock 206.

In the example implementation of FIG. 2, discrete analog circuits may be used to enable a digital monolithic circuit receiver implementation 201 in an FPGA or ASIC. This enables the use of an ADC with a much higher resolution and dynamic range compared to monolithic implementation. The ADC 206 may blindly sample at 1× or greater the symbol rate, with no phase relationship between samples and symbol boundaries. In the example of FIG. 2, the ITPL (interpolator) 208, and optionally, a FIFO (shown in 208), add interpolated samples to the data from the ADC 204. Digital FFE 112 and/or DFE 114 equalize interpolated samples for error-free data recovery. The fully digital clock (e.g., FDC 202) selects an ideal sample at the symbol rate, such that 1× samples are aligned with symbol centers.

FIG. 3 shows additional details of blind sampling and the fully digital clock. In FIG. 3, the use of discrete blocks allows the use of high-performance analog blocks, e.g., the low jitter sampling clock 206, and the high resolution and high dynamic range ADC 204. The sampling clock 206 operates blindly, i.e., the clock 206 is free running with respect to boundaries of received symbols. As the ADC sampling clock 206 is free-running, this allows for a low latency, fully digital clock recovery loop.

Referring again to FIG. 2, the combination of FIFO (optional) and interpolator (ITPL) (optional) 208, phase detector (PD 116) and FDC 202 effectively resample and phase-align the samples in the digital domain. The input to the FDC can use several different signals including, but not limited to, the interpolated, equalized ADC samples, unequalized & non-interpolated samples, interpolated and/or equalized samples. The source of recovered clock (FDC 202) is a digital algorithm with no impairments associated with analog clock sources. Interpolated baud-rate and phase-aligned samples allow the use of well-established equalization algorithms in digital circuits. Sample equalization and phase detection are completely contained in a digital circuit or an FPGA. As such, the data is sampled “blind” (e.g., in the Blind Sample block 210 of FIG. 2) with the high-performance sampling clock 206, operating at baud rate or greater.

The interpolated data is optionally fed to a feed-forward equalizer (FFE) 112 and/or a decision feedback equalizer (DFE) 114. These blocks can improve the received signal to mitigate effects such as channel distortion or intersymbol interference (ISI). Interpolated baud-rate and phase-aligned samples allow the use of well-established equalization algorithms in digital circuits, such as FFE 112 and DFE 114. Using the blind samples and the FDC 202, the baud rate samples are recovered via interpolation. In other words, the FDC 202 defines the ideal sample location, and provides a digital clock. The sample position is selected as the ideal position between the symbol boundaries.

The output of the interpolator (FIFO & ITPL) 208, FFE 112, DFE 114 path is fed into the phase detector (PD) 116. The phase detector 116 determines if the current sample position is early or late compared to the ideal sample position and generates an error signal proportional to the phase difference. The next stage is the loop filter (LF) 118, which limits how quickly the loop can adjust the phase. The loop filter implementation manages performance of loop bandwidth, phase noise, stability, lock time, etc. The combination of the FIFO (optional) and interpolator (ITPL) 208 effectively resamples and phase-aligns the sample in the digital domain. The source of the FDC 202 is a digital algorithm, which is free from impairments associated with analog clock sources.

Thus, comparing the CDR 200 of the present disclosure to conventional CDRs, there are several differences: the implementation is completely digital, the ADC sampled data is also interpolated, the ADC blindly samples the data stream at baud rate or greater, sample equalization and phase detection are completely contained in digital circuits, and the PI produces a fully digital clock, where both frequency and phase can be adjusted.

### Advantages of Implementations of the Present Disclosure

Implementations of the present disclosure, using a blind sampling ADC with a free running sample clock, and a fully digital clock and data recovery loop (CDR), decouples the ADC from the clock recovery loop and allows the digital circuit to be implemented in an ASIC or FPGA. The free running sample clock does not have any relationship to the data clock, in frequency or phase.

In addition, below is a non-exhaustive list of the advantages of using blind sampling with an ADC:

A real-time protocol analyzer and a real-time oscilloscope can be realized with the same hardware. For the end user of the instrument, this simplifies debugging and reduces cost. Real-time oscilloscopes typically have a very universal front end that can capture all types of signals. Being able to utilize this type of front end would allow the protocol analyzer to be just as universal.

A single protocol analyzer can decode one or more protocols with the same instrument or even within the same capture. Traditionally, each protocol needs its own analyzer instrument. Each instrument is customized for the protocol it supports, including items such as dedicated physical layer (PHY) ASICs. For example, there could be two different protocols in the same channel (e.g., over the air). The ADC would be able to capture all the frequencies up to Nyquist rate and there could be multiple CDRs processing the blind samples processing different protocols, using the same blind ADC samples.

Enables rapid prototyping, custom digital signal processing (DSP), and dynamic reconfiguration of physical SERDES and CDR implementation. For example, an FPGA can be easily modified to accommodate different SERDES and CDR implementations to support a myriad of protocols, covering applications much wider than just protocol analyzers.

The fully digital clock architecture can be implemented in an FPGA, hardened FPGA blocks, a dedicated ASIC, or software, improving signal capture and lowering metrics such as bit error rate across myriad of protocol applications.

Allows the use of a fully digital clock that can change both frequency and phase, with theoretically infinite resolution. The fully digital clock is programable, allowing the frequency to easily be changed. Traditional CDRs can only modify one or the other.

In one event capture on the same input signal (i.e. one physical input) and inherently time-correlated, both sampled analog data and/or decoded protocol can be triggered on and analyzed. This enables advanced triggering that can work on any of the following: the analog signal prior to the ADC, the digitized samples (i.e., a digital trigger), or any aspect of the protocol decode. Additionally, this allows trigger modes that cannot be realized on oscilloscopes or traditional protocol analyzers. For example, the trigger can be set to an analog signal property (i.e. a runt pulse) within a protocol mode (i.e. hibernate).

Enables real-time signal quality and margin measurements such as eye measurements and SNR, with or without equalization.

As used herein, the term “comprises” or “comprising” or “includes” or any other variations thereof is intended to encompass a non-exclusive inclusion, such that a process, method, article, or device that comprises a plurality of elements includes not only those elements but also other elements, or elements that are inherent to such a process, method, item, or device. Without more restrictions, the element defined by the phrase “include one” or the like does not exclude that there are other identical elements in the process, method, article or equipment that includes the element. In the present disclosure, if it is mentioned that an action is performed according to an element, it means the meaning of performing the action at least according to the element and includes two cases: the behavior is performed only on the basis of the element, and the behavior is performed based on the element and other elements.

Multiple, repeatedly, various, etc., expressions include 2, twice, 2 types, and 2 or more, twice or more, and 2 types or more types.

The term “coupled to” and its derivatives can be used herein. “Coupled” may mean that two or more elements are in direct physical or electrical contact. However, “coupled” may also mean that two or more elements are indirectly in contact with each other, but still cooperate or interact with each other, and may mean that one or more other elements are coupled between elements that are said to be coupled to or connected with each other.

While subject matter of the present disclosure has been illustrated and described in detail in the drawings and foregoing description, such illustration and description are to be considered illustrative or exemplary and not restrictive. Any statement made herein characterizing the implementations is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

1. A digital clock and data recovery (CDR) system, comprising:
a blind sampling circuit that receives an input sampled signal; and
a digital monolithic circuit that includes:
a phase detector (PD) that determines a phase error which is used to determine a unit interval (UI) center; and
a fully digital clock (FDC) that creates a digital clock used to recover digital data from the input sampled signal.

2. The CDR system of claim 1, further comprising:
an analog-to-digital converter (ADC); and
an ADC sample clock,
wherein the ADC sample clock drives the ADC to provide the input sampled signal.

3. The CDR system of claim 2, wherein the FDC operates independently of the input sampled signal or the ADC sample clock.

4. The CDR system of claim 2, wherein the ADC samples an incoming analog signal without a feedback loop from the digital monolithic circuit.

5. The CDR system of claim 2, wherein an ADC sample rate is greater than a baud rate.

6. The CDR system of claim 1, further comprising a loop filter (LF) circuit that uses the phase error from the PD and provides a phase adjustment to the FDC.

7. The CDR system of claim 1, the digital monolithic circuit further comprising:
at least one of a feed-forward equalizer (FFE) and a decision feedback equalizer (DFE),
wherein the at least one of the FFE and DFE provide equalized sampled data to the PD.

8. The CDR system of claim 1, the digital monolithic circuit further comprising: an interpolator that provides interpolated sample data to the PD.

9. The CDR system of claim 8, wherein a feed-forward equalizer (FFE) is placed ahead of the interpolator and operates on the sampled signal, rather than interpolated samples.

10. The CDR system of claim 1, wherein the CDR system resides in software.

11. The CDR system of claim 1, wherein the CDR system is integrated in a custom ASIC or a Field Programmable Gate Array (FPGA).

12. A method for sampling an analog input signal, comprising:
receiving an input sampled signal at a blind sampling circuit; and
recovering digital data from the input sampled signal using a phase detector (PD) that determines a phase error which is used to determine a unit interval (UI) center and a fully digital clock (FDC) that creates a digital clock used to recover digital data from the input sampled signal.

13. The method of claim 12, further comprising:
sampling the analog signal using an analog-to-digital converter (ADC); and
driving the ADC using an ADC sample clock to provide the input sampled signal.

14. The method of claim 13, further comprising operating the FDC independently of the analog input signal or the sample clock.

15. The method of claim 13, further comprising operating the ADC sample clock without a feedback loop from a digital monolithic circuit.

16. The method of claim 13, further comprising operating the ADC sample clock at greater than a baud rate.

17. The method of claim 12, further comprising:
using a loop filter (LF) circuit that that uses the phase error from the PD and provides a phase adjustment to the FDC.

18. The method of claim 12, further comprising:
using at least one of a feed-forward equalizer (FFE) and a decision feedback equalizer (DFE) that receives an output of an interpolator circuit; and
outputting an equalized signal to the PD.

19. The method of claim 18, where the FFE is placed ahead of the interpolator circuit and operates on the sampled signal, rather than interpolated rate samples.
